(19) United States
(12) Patent Application Publication
(10) Pub. No.: US 2018/0031069 A1
(43) Pub. Date: Feb. 1, 2018

(54) TUBULAR VIBRATION-DAMPING DEVICE

(71) Applicant: SUMITOMO RIKO COMPANY LIMITED, Komaki-shi (JP)

(72) Inventors: Kenji KURODA, Komaki-shi (JP); Motohiro KAWAI, Komaki-shi (JP)

(73) Assignee: SUMITOMO RIKO COMPANY LIMITED, Komaki-shi (JP)

(21) Appl. No.: 15/618,484

(22) Filed: Jun. 9, 2017

(30) Foreign Application Priority Data
Aug. 1, 2016 (JP) 2016-151487

(51) Int. Cl. F16F 1/38; B60K 5/12

(52) U.S. Cl. CPC F16F 1/38; B60K 5/1208

(57) ABSTRACT

A tubular vibration-damping device including: an inner axial member; an outer tubular member; and a main rubber elastic body connecting an outer peripheral surface of the inner axial member and an inner peripheral surface of the outer tubular member, wherein the outer peripheral surface of the inner axial member has an irregular shape including both lateral side faces with which a width of the inner axial member gets narrower in a lower side than in an upper side for an axis-perpendicular direction, and an inclination angle of a direction of each of the lateral side faces with which the width of the inner axial member gets narrower is larger in the lower side than in the upper side, and the lateral side faces respectively have groove-shaped concave portions formed extending continuously from the upper side to the lower side.

### INCORPORATED BY REFERENCE

The disclosure of Japanese Patent Application No. 2016-151487 filed on Aug. 1, 2016 including the specification, drawings and abstract is incorporated herein by reference in its entirety.

### BACKGROUND OF THE INVENTION

### 1. Field of the Invention

The present invention relates to a tubular vibration-damping device used for an automotive engine mount, a torque rod bushing, or the like.

### 2. Description of the Related Art

A tubular vibration-damping device used for an automotive engine mount, a torque rod bushing, or the like has been known from the past. As shown in FIG. 2 of Japanese Examined Utility Model Publication No. JP-Y-H07-046826, the tubular vibration-damping device has a structure wherein an inner tube is inserted in an outer tube and the outer peripheral surface of the inner tube and the inner peripheral surface of the outer tube are elastically connected by a rubber tube.

In the conventional tubular vibration-damping device shown in FIG. 2 of JP-Y-H07-046826, compression spring component of the rubber tube acts on a vibration input in the axis-perpendicular direction in a predominant manner, while shear spring component of the rubber tube acts on a vibration input in the axial direction in a predominant manner. This limits the degree of freedom in tuning the ratio between the spring in the axial direction and the spring in the axis-perpendicular direction. In light of that, it is known that the structure shown in FIG. 1 of JP-Y-H07-046826 enables tuning of the ratio between the spring in the axial direction and the spring in the axis-perpendicular direction with a greater degree of freedom. Specifically, by providing steps projecting to the periphery at both axial ends of the inner tube, it is possible to maintain the free length of the spring in the axis-perpendicular direction while reducing the free length of the spring in the axial direction, thereby hardening the spring in the axial direction.

However, with this structure shown in FIG. 1 of JP-Y-H07-046826, it is difficult to get a great degree of freedom in tuning the spring characteristics while securing the durability. Specifically, by providing the steps at the axial ends of the inner tube, the radial dimension for the axial end faces of the rubber tube becomes small, so that the free length of the surface of the rubber tube becomes small. Consequently, the tubular vibration-damping device suffers from reduction in the durability of the rubber tube. If the projecting dimension of the step at the inner tube is made small in order to sufficiently secure the durability of the rubber tube, it gets difficult to sufficiently keep the degree of freedom in tuning the spring ratio between the spring in the axial direction and the spring in the axis-perpendicular direction with respect to the rubber tube.

If the outer diameter of the axially middle portion of the inner tube out of the steps is made small in order to form the steps of the inner tube with a size large enough while sufficiently ensuring the radial free length for the axial end faces of the rubber tube, the peripheral length of the inner tube becomes short, whereby the fixation area of the rubber tube to the inner tube becomes small. As a result, the tubular vibration-damping device may suffer from reduction in the durability and the load bearing capability in relation to a load input in the axis-perpendicular direction. If the diameter of the outer tube is expanded without reducing the diameter of the inner tube, the tubular vibration-damping device becomes large and a larger space for disposing the tubular vibration-damping device may be required.

### SUMMARY OF THE INVENTION

It is therefore one object of the present invention to provide a tubular vibration-damping device of novel structure which is able to secure a great degree of freedom in tuning the ratio between the spring in the axial direction and the spring in the axis-perpendicular direction while obtaining excellent load bearing capability and durability.

The above and/or optional objects of this invention may be attained according to at least one of the following modes of the invention. The following modes and/or elements employed in each mode of the invention may be adopted at any possible optional combinations.

A first mode of the present invention provides a tubular vibration-damping device comprising: an inner axial member; an outer tubular member; and a main rubber elastic body connecting an outer peripheral surface of the inner axial member and an inner peripheral surface of the outer tubular member, wherein the outer peripheral surface of the inner axial member has an irregular shape including both lateral side faces with which a width of the inner axial member gets narrower in a lower side than in an upper side for an axis-perpendicular direction, and an inclination angle of a direction of each of the lateral side faces with which the width of the inner axial member gets narrower is larger in the lower side than in the upper side, and the lateral side faces respectively have groove-shaped concave portions formed extending continuously from the upper side to the lower side.

According to this tubular vibration-damping device constructed following the first mode, with attention on the facts that the load in the axis-perpendicular direction is generally exerted on the mounted tubular vibration-damping device in a specific direction and the load is seldom exerted equally to both sides in the specific direction, the spring in the axis-perpendicular direction and the spring in the axial direction can be set closer to the same, while realizing a high degree of load bearing capability and durability.

Specifically, for the axis-perpendicular direction in which the load is input (the up-down direction), by the both lateral side faces of the inner axial member extending in the up-down direction, the shear spring component is set to be great. Additionally, by the concave portions, the substantial free length of the main rubber elastic body in relation to the input in the axis-perpendicular direction is set to be long. This achieves lower spring in the axis-perpendicular direction. Moreover, the both lateral side faces of the inner axial member have a shape extending in the up-down direction. The shape secures bonding area of the main rubber elastic body to the inner axial member, thereby improving the durability and the load bearing capability.

In the both lateral side faces of the inner axial member, the faces inclined toward the respective directions such that the width of the inner axial member gets narrower are provided. This makes it possible to efficiently set appropriate spring characteristics especially in relation to the input load in the axis-perpendicular direction, while keeping the durability and the load bearing capability. Besides, the inner axial member has the irregularly-shaped outer peripheral surface with which the width of the inner axial member gets narrower in the lower side, whereby the rubber volume of the main rubber elastic body is largely ensured at the both lateral sides of the lower side portion of the inner axial member. For example, assuming a larger load is input to the upper side than to the lower side, the durability can be improved with respect to the tensile stress acting on the lower part of the main rubber elastic body. In addition, by providing the both lateral side faces of the inner axial member with sections slanting relative to the up-down direction, large areas of the both lateral side faces can be kept. As a result, a large fixation area of the main rubber elastic body in relation to the both lateral side faces of the inner axial member can be obtained, thereby improving the durability and the load bearing capability.

In the both lateral side faces of the inner axial member, the concave portions extending in the up-down direction are formed. This avoids the substantial reduction in the diameter of the inner axial member, while improving the degree of freedom in tuning the spring ratio between the spring in the axial direction and the spring in the axis-perpendicular direction for the main rubber elastic body. Therefore, it is possible to obtain a large fixation area of the main rubber elastic body to the inner axial member so as to secure the durability and the load bearing capability, while efficiently getting the target spring characteristics so as to improve the vibration-damping performance.

A second mode of the present invention provides the tubular vibration-damping device according to the first mode, wherein the main rubber elastic body includes an upper bore part and a lower bore part located respectively at an upper side and a lower side of the inner axial member in the axis-perpendicular direction.

According to the second mode, by forming the bore parts at the both upper and lower sides of the inner axial member, with respect to the spring characteristics in the axis-perpendicular direction in which the load is input (the up-down direction), the compression spring component of the main rubber elastic body is decreased, thereby making it easier to set the spring constant in the axis-perpendicular direction to be smaller.

A third mode of the present invention provides the tubular vibration-damping device according to the second mode, wherein both the upper bore part and the lower bore part in the main rubber elastic body are formed through the main rubber elastic body in an axial direction, and the upper bore part located at the upper side of the inner axial member has a larger left-right width dimension than a left-right width dimension between bottom parts of the concave portions provided at the lateral side faces in an upper side end face of the inner axial member, while the lower bore part located at the lower side of the inner axial member has a larger left-right width dimension than a left-right width dimension between the bottom parts of the concave portions provided at the lateral side faces in a lower side end face of the inner axial member.

According to the third mode, the bore parts are formed through the main rubber elastic body in the axial direction, thereby making it possible to set the spring in relation to an input in the up-down direction to be smaller. The left-right width dimension of each bore part is larger than the left-right width dimension between the bottom parts of the concave portions in the end face of the inner axial member on the side in the proximity of the corresponding bore part. This more effectively reduces the compression spring component of the main rubber elastic body in relation to the input in the up-down direction, thereby setting the spring component in the up-down direction to be smaller.

A fourth mode of the present invention provides the tubular vibration-damping device according to any one of the first to third modes, wherein, in upper sections of the lateral side faces of the inner axial member, a pair of opposite faces extending in an up-down direction as parallel to each other are provided.

According to the fourth mode, in the sections where the pair of opposite faces are provided, the compression spring component of the main rubber elastic body in relation to the input in the up-down direction becomes smaller. As a result, the degree of freedom in adjusting the spring characteristics gets greater, thereby making it possible to further improve the vibration-damping performance.

A fifth mode of the present invention provides the tubular vibration-damping device according to any one of the first to fourth modes, wherein the concave portions have an arcuate cross section.

According to the fifth mode, since the concave portions have an arcuate cross section, in the fixation parts of the main rubber elastic body to the concave portions, stress dispersion or the like is realized, thereby further improving the durability and the load bearing capability.

A sixth mode of the present invention provides the tubular vibration-damping device according to any one of the first to fifth modes, wherein each of the concave portions extends with a substantially constant cross sectional shape along a whole length thereof.

According to the sixth mode, in relation to the input in the axis-perpendicular direction (the up-down direction), the substantial free length of the main rubber elastic body is efficiently kept to be long, thereby making it possible to set the spring in the axis-perpendicular direction to be small.

A seventh mode of the present invention provides the tubular vibration-damping device according to any one of the first to sixth modes, wherein the inner axial member includes an upper side end face having a convex arcuate shape in a peripheral direction, and a lower side end face having a plane shape expanding in a left-right direction in the peripheral direction.

According to the seventh mode, in relation to different input to opposite sides in the up-down direction, it is possible to efficiently obtain vibration-damping effect for either. Also, the upper end face has a convex arcuate shape in the peripheral direction. Thus, a large area is secured for the upper end face, thereby making it possible as well to get a large attachment area of the main rubber elastic body to the inner axial member.

An eighth mode of the present invention provides the tubular vibration-damping device according to any one of the first to seventh modes, wherein the inner axial member protrudes further to both axial sides than the outer tubular member, while both axial ends of each of the concave portions of the inner axial member are positioned further axially outside than the outer tubular member, and an axial dimension of an inner peripheral part of the main rubber elastic body that is fixed on the outer peripheral surface of the inner axial member is larger than an axial dimension of an outer peripheral part of the main rubber elastic body that is fixed on the inner peripheral surface of the outer tubular member.

According to the eighth mode, a large axial dimension for the concave portions is kept. By so doing, it is possible to further improve the degree of freedom in adjusting the spring characteristics of the tubular vibration-damping device, while improving the durability and the load bearing capability. Moreover, it is easier to adjust the spring characteristics of the main rubber elastic body that is exhibited in relative displacement of the inner axial member and the outer tubular member in the prizing direction. As a result, it is also possible to improve the vibration-damping performance in relation to the input in the prizing direction.

A ninth mode of the present invention provides the tubular vibration-damping device according to any one of the first to eighth modes, wherein both side walls of each of the groove-shaped concave portions are positioned at both axial ends of the inner axial member and provided projecting on an outer periphery of the inner axial member.

According to the ninth mode, relative to the axial length of the inner axial member, it is possible to set the groove width of the concave portion efficiently largely, thereby keeping the rubber volume of the main rubber elastic body.

A tenth mode of the present invention provides the tubular vibration-damping device according to any one of the first to ninth modes, wherein both axial ends of the main rubber elastic body are positioned on outer peripheral faces of both side walls of each of the groove-shaped concave portions whose outer diameter dimensions are large in the inner axial member.

According to the tenth mode, it is possible to get a larger attachment area of the main rubber elastic body to the inner axial member, thereby improving the durability and the load bearing capability.

An eleventh mode of the present invention provides the tubular vibration-damping device according to any one of the first to tenth modes, wherein a slope angle of a groove bottom face in each of the groove-shaped concave portions of the inner axial member varies in a groove length direction.

According to the eleventh mode, by changing the degree of the slope angle, the change position of the slope angle, and the like for the groove bottom face of each concave portion, it becomes possible as well to tune the spring characteristics of the tubular vibration-damping device without changing the shape setting of the outer peripheral surface of the inner axial member.

According to the present invention, for the axis-perpendicular direction in which the load is input (the up-down direction), the shear component is set largely by the both lateral side faces of the inner axial member extending in the up-down direction. Additionally, the substantial free length of the main rubber elastic body for the input in the up-down direction is set to be long by the concave portions. This achieves lower spring in the up-down direction. Moreover, for the both lateral side faces of the inner axial member provided extending in the up-down direction, the faces inclined relative to the up-down direction are provided. Consequently, it is possible to set suitable spring characteristics especially with respect to an input load in the up-down direction, while ensuring the bonding area to the inner axial member and the free length for the main rubber elastic body, thereby improving the durability and the load bearing capability. In addition, by forming the concave portions extending in the up-down direction at the both lateral side faces of the inner axial member, it is possible to avoid substantial reduction in the diameter of the inner axial member. This can keep a large attachment area of the main rubber elastic body to the inner axial member.

### BRIEF DESCRIPTION OF THE DRAWINGS

The foregoing and/or other objects, features and advantages of the invention will become more apparent from the following description of a preferred embodiment with reference to the accompanying drawing in which like reference numerals designate like elements and wherein:

FIG. 1 is a front view of a tubular vibration-damping device in the form of an engine mount as a first embodiment of the present invention;

FIG. 2 is a cross sectional view taken along line 2-2 of FIG. 1;

FIG. 3 is a cross sectional view taken along line 3-3 of FIG. 1;

FIG. 4 is a perspective view of an inner axial member of the engine mount shown in FIG. 1; and

FIG. 5 is a perspective view showing the inner axial member of FIG. 4 at another angle.

### DETAILED DESCRIPTION OF PREFERRED EMBODIMENTS

There will be described below the embodiment of the present invention while referring to the drawing.

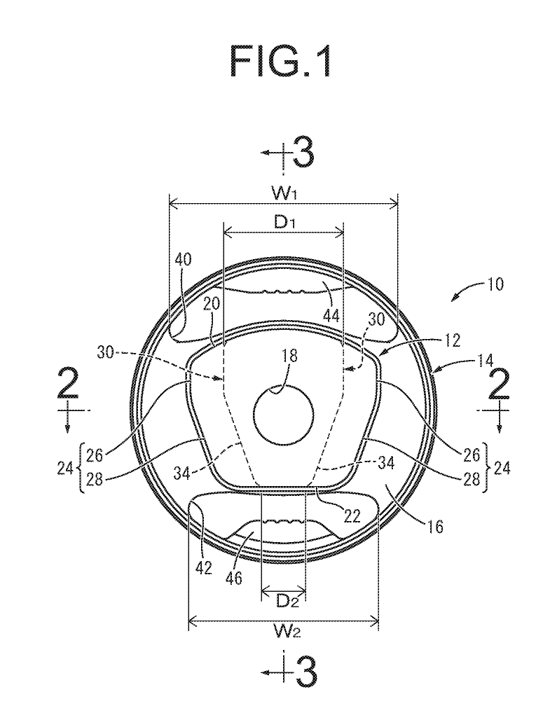

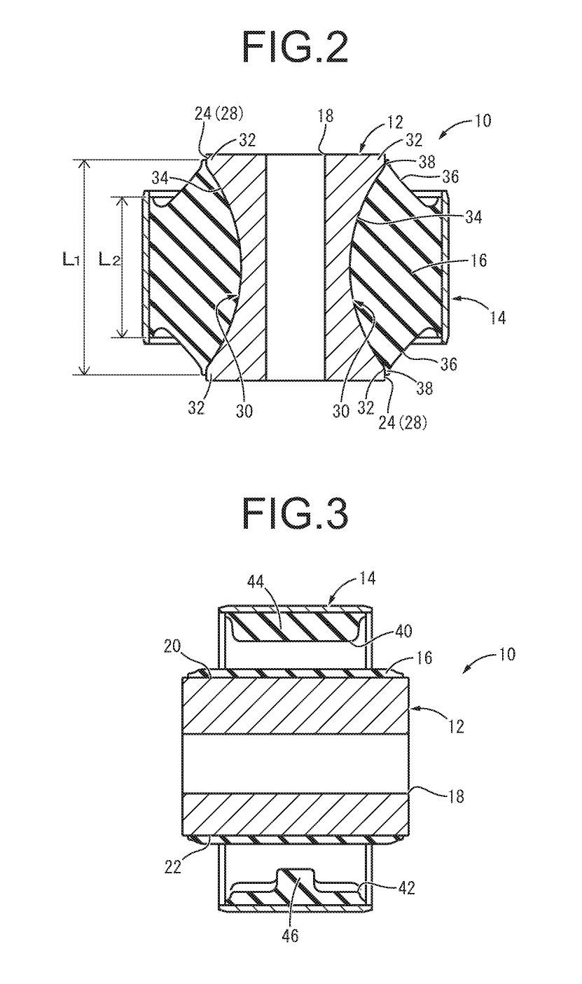

FIGS. 1 to 3 show an automotive engine mount 10 as a first embodiment of a tubular vibration-damping device structured according to the present invention. The engine mount 10 has a structure wherein the outer peripheral surface of an inner axial member 12 and the inner peripheral surface of an outer tubular member 14 are elastically connected by a main rubber elastic body 16. In the explanation hereinafter, the up-down direction means the up-down direction in FIG. 1, the left-right direction means the left-right direction in FIG. 2, and the front-back direction means the left-right direction in FIG. 3, which is the axial direction.

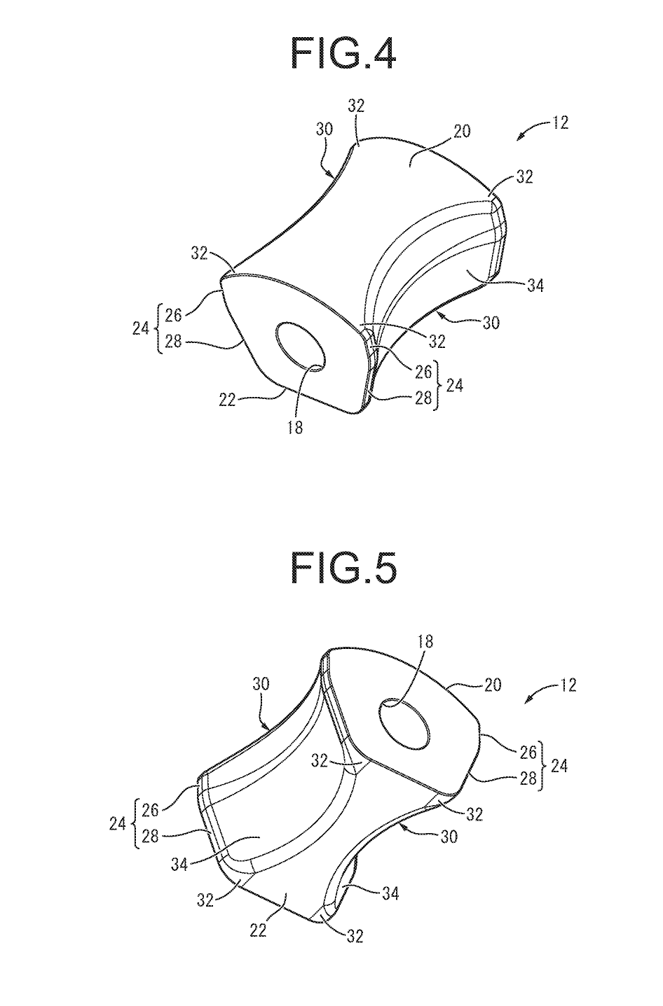

More specifically, the inner axial member 12 is a member of high rigidity that is formed of a metal, a synthetic resin, or the like. As FIGS. 4 and 5 show, the whole inner axial member 12 has a small-diameter rod shape including a bolt hole 18 penetrating it in the up-down direction. The inner axial member 12, as FIG. 1 shows an axial end face thereof, extends linearly in the axial direction with an irregular-shaped cross section. The outer peripheral surface of the inner axial member 12 has an upper side end face 20 and a lower side end face 22 that are spaced from each other in the up-down direction, and left and right lateral side faces 24, 24 that connect the upper side and lower side end faces 20, 22.

The upper side end face 20 of the inner axial member 12 has a convex arcuate shape in the peripheral direction of the inner axial member 12, and it is a curved face that is convex to the upper side. On the other hand, the lower side end face 22 of the inner axial member 12 has a plane shape expanding in the left-right direction, and expands in a direction substantially orthogonal to the up-down direction.

About the left and right lateral side faces 24, 24, the upper sections are opposite faces 26, 26 extending with little inclination relative to the up-down direction. The opposite face 26 of the left lateral side face 24 and the opposite face 26 of the right lateral side face 24 are disposed to face each other in the left-right direction, as substantially parallel to each other. The lower sections of the left and right lateral side faces 24, 24 are tapered faces 28, 28 that are inclined inward in the left-right direction as they go downward. Therefore, the inclination angles of directions of the left and right lateral side faces 24, 24 with which the width of the inner axial member 12 becomes narrower as it goes to the lower side are set larger in the lower sections than in the upper sections. In the present embodiment, each of the tapered faces 28, 28 of the left and right lateral side faces 24, 24 is an inclined flat face that is inclined at a generally constant angle. Alternatively, it is possible to have the inclination angle vary gradually or in a stepwise manner in the up-down direction for the left and right tapered faces 28, 28. The tapered faces 28, 28 are not always limited to flat faces.

In this way, each of the left and right lateral side faces 24, 24 of the inner axial member 12 has the tapered face 28, so that the width of the inner axial member 12 is narrower in the left-right direction in the lower part than in the upper part. The left-right width dimension of the upper side end face 20 of the inner axial member 12 is larger than that of the lower side end face 22. Thus, the outer peripheral surface of the inner axial member 12 has an irregular shape.

As FIGS. 2, 4, and 5 show, in the inner axial member 12, left and right concave portions 30, 30 are formed. The shapes of the concave portions 30 are grooves opening to the left and right lateral side faces 24, 24 and extending in the up-down direction. The concave portion 30 is formed to be continuous across the whole up-down length of the inner axial member 12 with a substantially constant cross sectional shape. Only one concave portion 30 is formed in the axial direction of the inner axial member 12, specifically at the axially central portion, opening in a range up to the proximities of the edges of the inner axial member 12. The concave portion 30 has an arcuate concave shape of cross section that is symmetrical about the axial center, so that the concave portion 30 is deepest at the axial center of the inner axial member 12. Both side walls 32, 32 of the concave portion 30 are positioned at the both axial ends of the inner axial member 12 and provided projecting on the outer periphery of the inner axial member 12. The inner axial member 12 has the largest outer diameter dimension at each of axial ends including the both side walls 32, 32 of the concave portion 30.

As shown by dashed lines in FIG. 1, in the upper part of the inner axial member 12, the concave portion 30 extends in the up-down direction along the opposite face 26, while in the lower part of the inner axial member 12, it extends tilting relative to the up-down direction along the tapered face 28. Consequently, the slope angle relative to the up-down direction of a groove bottom face 34 varies with two steps in the groove length direction. In this embodiment, the slope angles of directions of the groove bottom faces 34, 34 of the concave portions 30, 30 with which the left-right width of the inner axial member 12 gets narrower are larger in the lower side than in the upper side. In the present embodiment, the up-down length dimension of the upper portions with a smaller slope angle for the groove bottom faces 34, 34 of the concave portions 30, 30 is set smaller than the up-down length dimension for the opposite faces 26, 26 in the outer peripheral surface of the inner axial member 12. In other words, the change position of the slope angle for the groove bottom faces 34, 34 of the concave portions 30, 30 is located on the upper side of the change position of the inclination angle for the both lateral side faces 24, 24 of the inner axial member 12 (the boundary between the opposite face 26 and the tapered face 28).

The outer tubular member 14 is a high rigidity member formed of a metal or a synthetic resin with a substantially cylindrical shape having a thin wall and a large diameter. The axial length of the outer tubular member 14 is smaller than that of the inner axial member 12, and the axial width of the concave portion 30 formed in the inner axial member 12.

The inner axial member 12 is inserted in the outer tubular member 14, and the inner axial member 12 and the outer tubular member 14 are elastically connected by the main rubber elastic body 16. The main rubber elastic body 16 has a large-diameter tubular shape, and its inner peripheral face is bonded by vulcanization to the outer peripheral surface of the inner axial member 12, while its outer peripheral face is bonded by vulcanization to the inner peripheral surface of the outer tubular member 14.

Each axial end face of the main rubber elastic body 16 has an inclined end face 36 that is inclined to the axial outside as it goes to the radial inside. Consequently, the main rubber elastic body 16 is axially thicker in the radially inner ends of the inclined end faces 36, 36 than in the radially outer ends thereof. For the left-right inner faces of the main rubber elastic body 16, both axial ends 38, 38 are bonded to the portions of the inner axial member 12 that are located on the axial outsides of the concave portions 30, namely, the outer peripheral faces of the both side walls 32, 32 of the groove-shaped concave portions 30, 30, while the axially middle portions are bonded to the inner faces of the concave portions 30 of the inner axial member 12. Thus, the left-right inner faces of the main rubber elastic body 16 have an arcuate curved face that is convex inward in the left-right direction.

As FIG. 2 shows, the axial dimension L₁ of the inner peripheral part of the main rubber elastic body 16 which is bonded to the outer peripheral surface of the inner axial member 12 including the inner faces of the concave portions 30, 30, is larger than the axial dimension L₂ of the outer peripheral part thereof which is bonded to the inner peripheral surface of the outer tubular member 14. In short, the axial dimension of the inner axial member 12 is larger than the axial dimension of the outer tubular member 14. Besides, the axial dimension for the openings of the concave portions 30, 30 in the inner axial member 12 is larger than the axial dimension of the outer tubular member 14. Note that the inner axial member 12 is disposed such that the both axial ends thereof protrude further to the axial outsides than the outer tubular member 14 and the both axial ends of the concave portions 30, 30 are positioned further axially outside than the outer tubular member 14.

In the main rubber elastic body 16, an upper bore part 40 is formed. The upper bore part 40 passes through the main rubber elastic body 16 in the axial direction, at the upper side of the inner axial member 12. The upper bore part 40 has a flat-shaped hole cross section for which the left-right dimension is larger than the up-down dimension. Furthermore, as FIG. 1 shows, the left-right width dimension W₁ of the upper bore part 40 is larger than the distance D₁ (the left-right width dimension) between the bottom parts of the left and right concave portions 30, 30 in the upper side end face 20 of the inner axial member 12. In the present embodiment, the left-right width dimension W₁ of the upper bore part 40 is larger than the left-right width dimension of the inner axial member 12 at the parts out of the concave portions 30, 30 in the upper side end face 20 of the inner axial member 12.

Moreover, in the main rubber elastic body 16, a lower bore part 42 is formed. The lower bore part 42 passes through the main rubber elastic body 16 in the axial direction, at the lower side of the inner axial member 12. The lower bore part 42 has a flat-shaped hole cross section for which the left-right dimension is larger than the up-down dimension. Furthermore, the left-right width dimension W₂ of the lower bore part 42 is larger than the distance D₂ (the left-right width dimension) between the bottom parts of the left and right concave portions 30, 30 in the lower side end face 22 of the inner axial member 12. In the present embodiment, the left-right width dimension W₂ of the lower bore part 42 is larger than the left-right width dimension of the inner axial member 12 at the parts out of the concave portions 30, 30 in the lower side end face 22 of the inner axial member 12.

In sum, the upper bore part 40 and the lower bore part 42 formed in the main rubber elastic body 16 are disposed at the both upper and lower sides of the inner axial member 12 in the up-down direction. These upper and lower bore parts 40, 42 avoid compression of the main rubber elastic body 16 between the inner axial member 12 and the outer tubular member 14 in the up-down direction. Note that the left-right width dimension W₁ of the upper bore part 40 is larger than the left-right width dimension W₂ of the lower bore part 42.

The upper bore part 40 is formed in the main rubber elastic body 16, whereby an upper stopper rubber 44, which is formed integrally with the main rubber elastic body 16, is provided on the upper side of the upper bore part 40. The upper stopper rubber 44 is bonded to the inner peripheral surface of the outer tubular member 14, and it is disposed to face the inner axial member 12 across the upper bore part 40 in the up-down direction. In a face of the upper stopper rubber 44 on the side of the upper bore part 40, which faces the inner axial member 12, a plurality of grooves are formed extending in the axial direction, thereby improving cushioning performance of the upper stopper rubber 44.

The lower bore part 42 is formed in the main rubber elastic body 16, whereby a lower stopper rubber 46, which is formed integrally with the main rubber elastic body 16, is provided on the lower side of the lower bore part 42. The lower stopper rubber 46 is bonded to the inner peripheral surface of the outer tubular member 14, and it is disposed to face the inner axial member 12 across the lower bore part 42 in the up-down direction. In a face of the lower stopper rubber 46 on the side of the lower bore part 42, which faces the inner axial member 12, a plurality of grooves are formed extending in the axial direction, thereby improving cushioning performance of the lower stopper rubber 46. As FIGS. 1 and 3 show, the lower stopper rubber 46 has a stepped shape wherein the axial dimension of the projecting tip part is smaller than that of the base end part.

For the engine mount 10 of this structure, the inner axial member 12 is mounted by a not-shown bolt inserted in the bolt hole 18 to a power unit, which is not shown, either, while the outer tubular member 14 is mounted to a not-shown vehicle body, for example. By so doing, the engine mount 10 is mounted on the vehicle to connect the power unit to the vehicle body in a vibration-damping manner. In this mounted state to the vehicle, a load (vibration) input between the inner axial member 12 and the outer tubular member 14 causes elastic deformation of the main rubber elastic body 16. Then, energy loss action based on internal friction of the main rubber elastic body 16 and the like reduce the vibration transmitted to the vehicle body. The inner axial member 12 and the outer tubular member 14 are not always required to be mounted directly on the power unit and the vehicle body, and they may be mounted indirectly on them via a not-shown bracket, etc.

When a large load input in the up-down direction makes the inner axial member 12 and the outer tubular member 14 undergo relatively large displacement, the inner axial member 12 and the outer tubular member 14 get into indirect contact via the upper stopper rubber 44 or the lower stopper rubber 46. This constitutes an axis-perpendicular stopper that limits the up-down relative displacement amount of the inner axial member 12 and the outer tubular member 14. Especially in the present embodiment, in the upper side, which is expected to receive a larger load input, the upper side end face 20 of the inner axial member 12 is a curved face that is curved in the peripheral direction. In addition to that, the axial dimension of the upper stopper rubber 44 is made large. These secure a large stopper contact area in the axis-perpendicular stopper in the upper side, thereby improving the load bearing capability. On the other hand, in the lower side, which is expected to receive a smaller load input than the upper side, the lower side end face 22 of the inner axial member 12 is a flat face. In addition to that, the tip part of the lower stopper rubber 46 has a small axial dimension. These reduce an impulse in the initial period of contact between the inner axial member 12 and the lower stopper rubber 46, thereby realizing good riding comfort etc.

Here, for the engine mount 10, it is possible to set values closer to each other with respect to the spring constant in relation to the input in the front-back direction (the axial direction) and the spring constant in relation to the input in the up-down direction (the axis-perpendicular direction). For the spring constant in the front-back direction and the spring constant in the up-down direction, it is even possible to set their ratios to each other to be nearly one. Specifically, for the engine mount 10, the concave portions 30, 30 extending in the up-down direction are formed in the left and right lateral side faces 24, 24 of the inner axial member 12, while the main rubber elastic body 16 enters the concave portions 30, 30 so as to be bonded to the inner axial member 12. Consequently, in relation to the input in the up-down direction, the substantial left-right free length of the main rubber elastic body 16 is made large, whereby the spring constant in the up-down direction is set small. Meanwhile, in relation to the input in the front-back direction, the substantial left-right free length of the main rubber elastic body 16 is made small, whereby the spring constant in the front-back direction is prevented from being small. As a result, the difference between the spring constant in the up-down direction and the spring constant in the front-back direction becomes small, so that their ratios to each other can be set close to one.

The concave portion 30 is formed to extend continuously across the entire up-down length of the inner axial member 12, with a generally constant cross sectional shape across the entire length. This effectively sets a long free length of the main rubber elastic body 16 for the input in the up-down direction, thereby making it possible to set a small spring in the up-down direction.

Besides, the slope angle of the groove bottom face 34 in the concave portion 30 of the inner axial member 12 varies in the groove length direction. Owing to this, by changing the degree of the slope angle, the up-down position of the change point of the slope angle, or the like for the groove bottom face 34 of the concave portion 30, it is also possible to tune the spring characteristics of the engine mount 10 without changing the shape setting of the outer peripheral surface of the inner axial member 12. Especially in this embodiment, the up-down length dimension for the upper portions of the groove bottom faces 34, 34 of the concave portions 30, 30 is set small compared to the up-down length dimension for the opposite faces 26, 26 in the outer peripheral surface of the inner axial member 12, thereby tuning the spring characteristics.

The both side walls 32, 32 of the groove-shaped concave portion 30 are positioned at both axial ends of the inner axial member 12 and provided projecting on the outer periphery of the inner axial member 12. Owing to this, it is possible to largely set the groove width dimension of the concave portion 30 by comparison with the axial length of the inner axial member 12, thereby ensuring the rubber volume for the main rubber elastic body 16. This advantageously improves the degree of freedom in tuning the spring characteristics, the durability, and the like with respect to the main rubber elastic body 16.

Since the left and right lateral side faces 24, 24 of the inner axial member 12 extend in the up-down direction, in the input in the up-down direction, the shear spring component of the main rubber elastic body 16, which is bonded to the left and right lateral side faces 24, 24 of the inner axial member 12, acts in a predominant manner, thereby achieving lower spring in the up-down direction. Additionally, the upper sections of the left and right lateral side faces 24, 24 of the inner axial member 12 are the opposite faces 26, 26 expanding in the up-down direction. As a result, in relation to the input in the up-down direction, the shear spring component of the main rubber elastic body 16 further predominates. This makes it possible to set a smaller spring constant in the up-down direction.

In the present embodiment, the upper bore part 40 and the lower bore part 42 are formed at the both sides of the inner axial member 12 in the up-down direction, so that the compression spring of the main rubber elastic body 16 is decreased in the input in the up-down direction. Especially in this embodiment, the left-right width dimension W₁ of the upper bore part 40 is larger than the distance D₁ between the bottom parts of the left and right concave portions 30, 30 in the upper side end face 20 of the inner axial member 12. Moreover, the left-right width dimension W₂ of the lower bore part 42 is larger than the distance D₂ between the bottom parts of the left and right concave portions 30, 30 in the lower side end face 22 of the inner axial member 12. This efficiently reduces the compression spring of the main rubber elastic body 16 in relation to the input in the up-down direction. Owing to this, the spring constant in the up-down direction is set even smaller, and the spring ratio between the front-back direction and the up-down direction can be adjusted with a greater degree of freedom.

Since the left and right lateral side faces 24, 24 of the inner axial member 12 have a shape extending in the up-down direction, the bonding area of the main rubber elastic body 16 to the inner axial member 12 in the left and right lateral side faces 24, 24 is largely kept, thereby improving the durability and the load bearing capability. Furthermore, the lower sections of the left and right lateral side faces 24, 24 of the inner axial member 12 are the tapered faces 28, 28. As a result, the areas of the left and right lateral side faces 24, 24 are largely secured, whereby the bonding areas of the main rubber elastic body 16 to the left and right lateral side faces 24, 24 are largely obtained, thereby improving the durability and the load bearing capability.

In the left and right lateral side faces 24, 24 of the inner axial member 12, the concave portions 30, 30 are formed extending in the up-down direction. This enables improvement of the degree of freedom in tuning the spring ratio between the axial direction and the axis-perpendicular direction in the main rubber elastic body 16 as well as avoidance of substantial reduction in the diameter of the inner axial member 12. As a result, it is possible to favorably obtain the target vibration-damping performance while sufficiently getting the bonding area of the main rubber elastic body 16 to the inner axial member 12, thereby improving the durability and the load bearing capability. Especially in this embodiment, the axial dimension for the concave portions 30, 30 is largely secured, while the axial dimension L₁ of the bonding part of the main rubber elastic body 16 to the inner axial member 12 is larger than the axial dimension L₂ of the bonding part of the main rubber elastic body 16 to the outer tubular member 14. Therefore, it is possible to adjust the spring characteristics of the engine mount 10 with a larger degree of freedom, while advantageously improving the durability and the load bearing capability.

Besides, the both axial ends 38, 38 of the main rubber elastic body 16 are positioned on the outer peripheral faces of the both side walls 32, 32 of the concave portion 30. The bonding area of the main rubber elastic body 16 to the inner axial member 12 can be attained more largely, thereby improving the durability and the load bearing capability.

The inner faces of the concave portions 30, 30 are curved faces with a nearly arcuate cross section. Thus, it is possible as well to disperse stress in the bonding parts of the main rubber elastic body 16 to the concave portions 30, 30.

The inner axial member 12 protrudes further axially outside than the outer tubular member 14, while the both axial ends of the concave portions 30, 30 in the inner axial member 12 are positioned further axially outside than the outer tubular member 14. This makes it easy to adjust the spring characteristics of the main rubber elastic body 16 exerted in relative displacement of the inner axial member 12 and the outer tubular member 14 in the prizing direction. Therefore, it is possible to improve the vibration-damping performance with respect to the input in the prizing direction.

The engine mount 10 of this embodiment presumes that, in the load in the up-down direction input when the engine mount 10 is mounted on the vehicle, the load to the upper side is larger than the load to the lower side. Considering the load magnitude difference in the up-down direction, for the engine mount 10, the upper side end face 20 of the inner axial member 12 has a larger left-right width dimension than that of the lower side end face 22 thereof. Owing to this, in the lower end of the main rubber elastic body 16 on which the tensile stress concentrates when the load to the upper side is input (the parts located upper than the left and right ends of the lower bore part 42), a large section permitted to undergo elastic deformation without being constrained by the inner axial member 12 is kept. This improves the durability of the main rubber elastic body 16.

The embodiment of the present invention has been described above, but this invention is not limited by the specific description of the embodiment. For example, the left and right lateral side faces 24, 24 of the inner axial member 12 are not limited to the structure including the opposite faces 26, 26 that extend in the up-down direction without slanting. The entire left and right lateral side faces 24, 24 may be inclined faces that are inclined to the left-right insides as they go downward, while having the inclination angle for the lower sections thereof be larger than the inclination angle for the upper sections thereof.

The concave portions 30, 30 formed in the left and right lateral side faces 24, 24 of the inner axial member 12 are not required to have constant depth dimensions and constant cross sectional shapes across the whole length for the concave portions 30, 30. The concave portions 30, 30 may have the depth dimension and the cross sectional shape vary in the length direction, considering the required vibration-damping characteristics, load bearing capability, durability, and the like. The concave portions 30, 30 can be formed across the whole up-down length of the inner axial member 12 like the above-mentioned embodiment. Alternatively, it is possible to use a structure wherein the concave portions 30, 30 have a groove shape whose bottom becomes gradually shallower as it goes toward the up-down ends to substantially disappear at the up-down ends.

The cross sectional shape for the concave portions 30, 30 is desirably an arcuate shape, and can be changed as appropriate. For example, it is also possible to adopt a rectangular cross section, a cross section having a shape wherein the bottom has a plurality of steps and gets deeper in a stepwise manner as it goes to the axial center, a cross section having an inclined bottom shape wherein the bottom face which is constituted by an inclined flat face is gradually deeper as it goes to the axial center, and the like. The concave portions 30, 30 may be formed in positions decentered to either axial side from the axial center of the inner axial member 12.

The specific shapes for the upper side end face 20 and the lower side end face 22 of the inner axial member 12 are not especially limited. For example, it is also possible to form a concave groove extending in the left-right direction in at least one of these upper side end face 20 and lower side end face 22.

In the aforesaid embodiment, the outer tubular member 14 has a generally circular shape. Alternatively, it is possible to apply this invention to a tubular vibration-damping device including an outer tubular member whose shape is an oval tube or a polygonal tube.

Also, the up-down direction of the tubular vibration-damping device does not always mean the vertical direction. For example, the axial direction of the tubular vibration-damping device can be the vertical direction, and the up-down direction of the tubular vibration-damping device that is the input direction of the main load may be the front-back direction or the left-right direction for the vehicle.

The tubular vibration-damping device according to the present invention is not applied only to the engine mount, and it can be applied to a sub-frame mount, a suspension bushing, a torque rod bushing, or the like, for example. Additionally, the application scope of this invention is not limited to the automotive tubular vibration-damping device. The present invention can be preferably applied as well to a tubular vibration-damping device that is used for a motorcycle, a railway vehicle, an industrial vehicle, or the like.

What is claimed is:

1. A tubular vibration-damping device comprising:
an inner axial member;
an outer tubular member; and
a main rubber elastic body connecting an outer peripheral surface of the inner axial member and an inner peripheral surface of the outer tubular member, wherein
the outer peripheral surface of the inner axial member has an irregular shape including both lateral side faces with which a width of the inner axial member gets narrower in a lower side than in an upper side for an axis-perpendicular direction, and an inclination angle of a direction of each of the lateral side faces with which the width of the inner axial member gets narrower is larger in the lower side than in the upper side, and the lateral side faces respectively have groove-shaped concave portions formed extending continuously from the upper side to the lower side.

2. The tubular vibration-damping device according to claim 1, wherein the main rubber elastic body includes an upper bore part and a lower bore part located respectively at an upper side and a lower side of the inner axial member in the axis-perpendicular direction.

3. The tubular vibration-damping device according to claim 2, wherein both the upper bore part and the lower bore part in the main rubber elastic body are formed through the main rubber elastic body in an axial direction, and the upper bore part located at the upper side of the inner axial member has a larger left-right width dimension than a left-right width dimension between bottom parts of the concave portions provided at the lateral side faces in an upper side end face of the inner axial member, while the lower bore part located at the lower side of the inner axial member has a larger left-right width dimension than a left-right width dimension between the bottom parts of the concave portions provided at the lateral side faces in a lower side end face of the inner axial member.

4. The tubular vibration-damping device according to claim 1, wherein, in upper sections of the lateral side faces of the inner axial member, a pair of opposite faces extending in an up-down direction as parallel to each other are provided.

5. The tubular vibration-damping device according to claim 1, wherein the concave portions have an arcuate cross section.

6. The tubular vibration-damping device according to claim 1, wherein each of the concave portions extends with a substantially constant cross sectional shape along a whole length thereof.

7. The tubular vibration-damping device according to claim 1, wherein the inner axial member includes an upper side end face having a convex arcuate shape in a peripheral direction, and a lower side end face having a plane shape expanding in a left-right direction in the peripheral direction.

8. The tubular vibration-damping device according to claim 1, wherein the inner axial member protrudes further to both axial sides than the outer tubular member, while both axial ends of each of the concave portions of the inner axial member are positioned further axially outside than the outer tubular member, and an axial dimension of an inner peripheral part of the main rubber elastic body that is fixed on the outer peripheral surface of the inner axial member is larger than an axial dimension of an outer peripheral part of the main rubber elastic body that is fixed on the inner peripheral surface of the outer tubular member.

9. The tubular vibration-damping device according to claim 1, wherein both side walls of each of the groove-shaped concave portions are positioned at both axial ends of the inner axial member and provided projecting on an outer periphery of the inner axial member.

10. The tubular vibration-damping device according to claim 1, wherein both axial ends of the main rubber elastic body are positioned on outer peripheral faces of both side walls of each of the groove-shaped concave portions whose outer diameter dimensions are large in the inner axial member.

11. The tubular vibration-damping device according to claim 1, wherein a slope angle of a groove bottom face in each of the groove-shaped concave portions of the inner axial member varies in a groove length direction.
